(19) United States
(12) Patent Application Publication
(10) Pub. No.: US 2018/0275659 A1
(43) Pub. Date: Sep. 27, 2018

(54) ROUTE GENERATION APPARATUS, ROUTE CONTROL SYSTEM AND ROUTE GENERATION METHOD

(71) Applicant: KABUSHIKI KAISHA TOSHIBA, Tokyo (JP)

(72) Inventors: Toshiyuki ONO., Otawara (JP); Yusuke MORIUCHI., Tokyo (JP); Wataru ASANO., Yokohama (JP)

(73) Assignee: KABUSHIKI KAISHA TOSHIBA, Tokyo (JP)

(21) Appl. No.: 15/691,934

(22) Filed: Aug. 31, 2017

(30) Foreign Application Priority Data
Mar. 21, 2017 (JP) 2017-055070
Jul. 12, 2017 (JP) 2017-136032

(51) Int. Cl. G05D 1/00; G06T 7/55; G06T 17/00; G06T 7/246; G06K 9/20; G05D 1/10

(52) U.S. Cl. CPC G05D 1/0094; G06T 7/55; G06T 17/00; H04B 7/185; G06K 9/2054; G05D 1/0011; G05D 1/101; G06T 7/246

(57) ABSTRACT

According to one embodiment, a route generation apparatus includes a memory and a circuit coupled with the memory. The circuit acquires a depth image regarding a capturing object including a first object, generates three-dimensional data by using the depth image receives first region information that specifies a first region including at least part of the first object based on the three-dimensional data, and generates route data by using the first region information and the three-dimensional data.

### CROSS-REFERENCE TO RELATED APPLICATIONS

This application is based upon and claims the benefit of priority from Japanese Patent Applications No. 2017-055070, filed Mar. 21, 2017; and No. 2017-136032, filed Jul. 12, 2017, the entire contents of all of which are incorporated herein by reference.

### FIELD

Embodiments described herein relate generally to a route generation apparatus, a route control system, and a route generation method.

### BACKGROUND

In recent years, a moving object such as drone may be used for checking appearances of large constructs such as bridges and tunnels. For example, a camera mounted on a drone can acquire images of constructs, and the images achieve checking parts that a person can hardly access.

Various techniques use distance data on a distance measured to an object to create a 3D model of the object. A computer displays the 3D model of the object on a screen and a user can sterically recognize the object by the displayed 3D model.

### BRIEF DESCRIPTION OF THE DRAWINGS

FIG. 1 is a diagram for explaining a configuration of a route control system including a route generation apparatus according to a first embodiment.

FIG. 2 is a perspective view illustrating an exemplary appearance of a drone in the route control system of FIG. 1.

FIG. 3 is a block diagram illustrating an exemplary system configuration of the drone of FIG. 2.

FIG. 4 is a block diagram illustrating an exemplary system configuration of an image capture device provided on the drone of FIG. 2.

FIG. 5 is a diagram illustrating an exemplary configuration of a filter provided in the image capture device of FIG. 4.

FIG. 6 is a diagram illustrating exemplary transmittance characteristics of the filter of FIG. 5.

FIG. 7 is a diagram for explaining a change in light rays and a blur shape due to a color-filtered aperture on which the filter of FIG. 5 is arranged.

FIG. 8 is a diagram for explaining an exemplary method for using blur on an image captured by the image capture device of FIG. 4 to calculate a distance to an object.

FIG. 9 is a block diagram illustrating an exemplary functional configuration of the image capture device of FIG. 4.

FIG. 10 is a block diagram illustrating an exemplary system configuration of the route generation apparatus of the embodiment.

FIG. 11 is a block diagram illustrating an exemplary functional configuration of a route generation program executed by the route generation apparatus of the embodiment.

FIG. 12 is a block diagram illustrating an exemplary system configuration of a tablet computer in the route control system of FIG. 1.

FIG. 13 is a block diagram illustrating an exemplary functional configuration of a region designation application program executed by the tablet computer of FIG. 12.

FIG. 14 is a diagram illustrating an example of designating a region on a 3D model in the tablet computer of FIG. 12.

FIG. 15 is a diagram for explaining an example of generating route data of the drone based on the region designated on the 3D model of FIG. 13.

FIG. 16 is a diagram illustrating an example of designating a region on a projection image in the tablet computer of FIG. 12.

FIG. 17 is a diagram for explaining an example of generating route data of the drone based on the region designated on the projection image of FIG. 16.

FIG. 18 is a diagram illustrating in an exemplary check screen including an image captured based on the route data of FIG. 15 or 17.

FIG. 19 is a flowchart illustrating an example of the procedure of processing performed by the drone of FIG. 2.

FIG. 20 is a flowchart illustrating an example of the procedure of processing performed by the route generation apparatus of the embodiment.

FIG. 21 is a flowchart illustrating an example of the procedure of processing performed by the tablet computer of FIG. 12.

FIG. 22 is a flowchart illustrating another example of the procedure of processing performed by the route generation apparatus of the embodiment.

FIG. 23 is a flowchart illustrating another example of the procedure of processing performed by the tablet computer of FIG. 12.

FIG. 24 is a diagram for explaining a configuration of a route control system including a route generation apparatus according to a second embodiment.

### DETAILED DESCRIPTION

Various embodiments will be described hereinafter with reference to the accompanying drawings.

In general, according to one embodiment, a route generation apparatus includes a memory and a circuit coupled with the memory. The circuit acquires a depth image regarding a capturing object including a first object, generates three-dimensional data by using the depth image receives first region information that specifies a first region including at least part of the first object based on the three-dimensional data, and generates route data by using the first region information and the three-dimensional data.

### First Embodiment

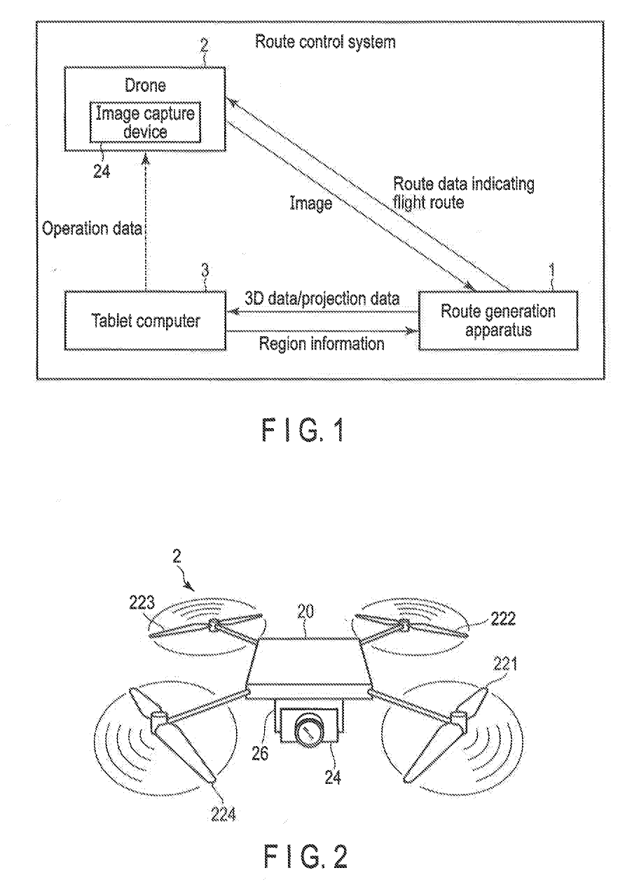

A configuration of a route control system including a route generation apparatus according to a first embodiment will be described with reference to FIG. 1. The route control system is configured to control a route in which a moving object moves. When an appearance of a large construct such as bridge or tunnel, including distortion or cracks, is checked, for example, the route control system controls a route of a moving object moving for capturing the construct.

The route control system includes the route generation apparatus, a moving object, and an input terminal. The route generation apparatus 1 may be realized as a server computer, for example. The input terminal may be realized as a tablet computer, a smartphone, or a personal digital assistant (PDA). The moving object may be realized as unmanned aerial vehicle, autonomous mobile robot or self-driving car, for example. The unmanned aerial vehicles such as airplanes, rotorcrafts, gliders, and airships on which persons are not allowed to board can fly by remote operation or automatic operation, and include drones (multicopters), radio-controlled machines, and crop-spraying helicopters. The route generation apparatus 1 may be provided on the moving object, or may be provided on the input terminal. In this case, the route generation apparatus 1 can make wireless or wired communication with the moving object and the input terminal.

In the following, a case where the moving object is a drone 2 and the input terminal is a tablet computer 3 will be exemplified in order to help with understanding.

When a camera mounted on the drone 2 acquires images of a construct, the images achieve checking a part at a height or in a shape that a person can hardly access, and the check record can be easily saved as data. However, efficiently and completely acquiring the images requires an experienced operator of the drone 2, and capturing in a wide range may cause large human loads. A manual operation of the drone 2 typically requires an operator per drone 2. Thus, reducing the loads on the operation of the drone 2 needs a new function of automatically creating a flight plan of the drone 2.

In the present embodiment, the route control system uses a three-dimensional (3D) model or its projection image created by using a depth image of a construct to be checked, and causes a user to designate a region including part of the construct. In accordance with the designation, the route control system automatically creates a flight plan of the drone 2 for acquiring images of the region. For example, the user only designates a region including part of a 3D model or its projection image of a construct at the site for check so that the route control system can automatically create a flight route of the drone 2 in order to acquire images of a region on the actual construct corresponding to the designated region. Thereby, the route control system can reduce the human loads on the operation of the drone 2 and can easily set a flight route of the drone 2 in order to capture the designated region of the construct. The route control system uses the images captured during the flight of the drone 2 in the set flight route to check the construct efficiently.

As illustrated in FIG. 1, the drone 2 includes an image capture device 24. The image capture novice 24 can continuously acquire images by capturing during flight of the drone 2. The drone 2 receives operation data based on operations by a user using a dedicated remote controller (not illustrated) or using an application program executed on the tablet computer in accordance with the operation data, the drone 2 is remotely controlled in takeoff, landing, turning, acceleration, deceleration and the like thereby to be manually operated. Operations by the user using the remote controller or the like can instruct the image capture device 24 to change its posture or to start or finish capturing. The drone 2 may use various position/posture sensors such as GPS receiver or inertia sensor to travel in a preset route automatically.

For example, when an appearance of a construct (hereinafter, also referred to as a first object) is checked, the drone 2 flies according to user's remote operations and uses the image capture device 24 during the flight to acquire images for creating a 3D model of the construct. The drone 2 transmits the acquired images to the route generation apparatus 1.

The route generation apparatus 1 uses the images received from the drone 2 to generate 3D data indicating a 3D model of the construct. The route generation apparatus 1 transmits the generated 3D data to the tablet computer 3.

The tablet computer 3 uses the received 3D data to displays the 3D model on the screen, and receives a user operation for designating a region which includes part of the displayed 3D model. Acquiring further detailed images for checking the appearance of the construct uses the designated region. The tablet computer 3 transmits region information on the designated region to the route generation apparatus 1.

The route generation apparatus 1 uses the region information to generate route data indicating a flight route and transmits the route data to the drone 2. The flight route causes the drone 2 to fly such that the drone 2 acquires images of the designated region.

While the drone 2 is flying based on the route data, the drone 2 uses the image capture device 24 to acquire images of the construct. The drone 2 transmits the acquired images to the route generation apparatus 1 or the tablet computer 3. The user browses the images together with the 3D model of the construct. Thereby, the user can use the images of the designated region on the construct to check the appearance of the construct.

The route generation apparatus 1 may project the 3D model on two-dimensional plane like the horizontal plane to generate projection data, and may transmit the projection data to the tablet computer 3. In this case, the tablet computer 3 uses the projection data to display the projection image on the screen, and receives a user operation of designating a region which includes part of the displayed projection image. The tablet computer 3 then transmits region information on the designated region on the projection image to the route generation apparatus 1.

As in the case of designating a region on the 3D model, the route generation apparatus uses the region information 1 to generate route data indicative of a flight route and transmits the generated route data to the drone 2. The flight route causes the drone 2 to fly such that the drone 2 acquires images of the designated region. While the drone 2 is flying based on the route data, the image capture device 24 acquires images of the construct.

Then, FIG. 2 illustrates an exemplary appearance of the drone 2. The drone 2 includes a main body 20 and four propeller units 221, 222, 223, and 224. Each of the propeller units 221, 222, 223, and 224 includes a propeller and a motor. The motor drives the propeller so that the propeller rotates and the drone 2 floats by lift due to the rotation.

The main body 20 mounts on, for example, its lower part, the image capture device 24 and a posture control device 26 for changing a posture (orientation) of the image capture device 24. The image capture device 24 can take any posture in response to an operation of the posture control device 26. The main body 20 mounts on not only its lower part but also top or side of it, the image capture device 24 and the posture control device 26. A drone 2 may be attached with multiple image capture devices 24. The route control system may use a plurality of drones 2, on which an image capture device 24 is attached at a different position.

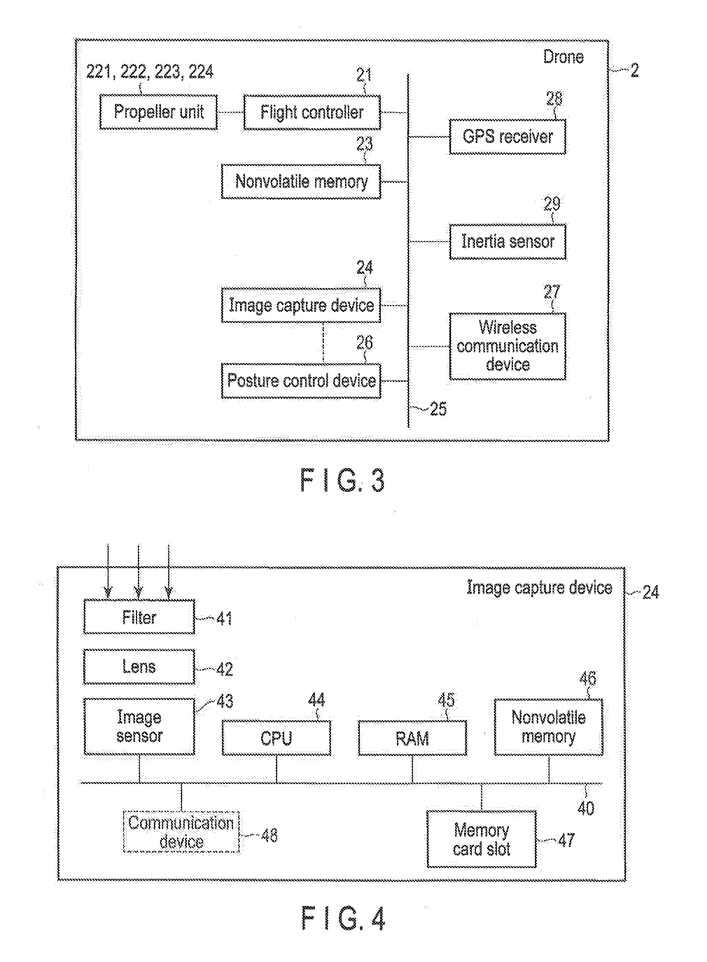

As illustrated in FIG. 3, the drone 2 includes a flight controller 21, a nonvolatile memory 23, the image capture device 24, the posture control device 26, a wireless communication device 27, a GPS receiver 28, an inertia sensor 29, and the like.

The flight controller 21 controls revolutions of the propeller units 221, 222, 223, and 224 thereby to control a flight speed, a flight direction, and the like of the drone 2. The flight controller 21 controls the propeller units 221, 222, 223, and 224 such that the drone 2 travels according to the manual operations. The flight controller 21 may control the propeller units 221, 222, 223, and 224 such that the drone 2 automatically travels in a set route. The flight controller 21 controls the propeller units 221, 222, 223, and 224 such that the drone 2 automatically travels in a flight route indicated in route data received from the route generation apparatus 1, for example.

The flight controller 21 may control the propeller units 221, 222, 223, and 224 such that the drone 2 travels in semi-automatic operation. The flight controller 21 uses, for example, the operation data of user' s manual operation and the route data received from the route generation apparatus 1 to control the propeller units 221, 222, 223, and 224 such that a distance to the construct is kept constant while performing takeoff, landing, turning, acceleration, deceleration, and the like indicated in the operation data. Thereby, the user can easily operate the drone 2 at a high difficulty level such as capturing a tilted plane of a construct. The user can switch the manual operation based on only the operation data, the semi-automatic operation based on the operation data and the route data, and the automatic operation based on only the route data as needed by a user operation or the like.

The image capture device 24 generates images by capturing during flight of the drone 2. Thus, the image capture device 24 can acquire images of an object viewed from the flying drone 2. A detailed configuration of the image capture device 24 will be described below with reference to FIGS. 4 to 9.

The posture control device 26 changes the image capture device 24 in any posture. The posture control device 26 sets an orientation of the image capture device 24 or an orientation (yaw, pitch, and roll) of the optical axis of the camera at an angle suitable to capture an object. The posture control device 26 changes a posture of the image capture device 24 such that the optical axis of the camera is perpendicular to a plane of a capturing target object. The posture control device 26 can change a posture of the image capture device 24 based on the data on a posture of the image capture device 24 included in the route data received from the route generation apparatus 1, for example.

The wireless communication device 27 communicates wirelessly. The wireless communication device 27 includes a transmitter transmitting a signal wirelessly and a receiver receiving a signal wirelessly.

The GPS receiver 28 receives GPS signals transmitted from GPS satellites. The GPS receiver 20 uses the received GPS signals to acquire position data (latitude and longitude) on a current position of the drone 2.

The inertia sensor 29 acquires posture data of the drone 2. The inertia sensor 29 includes, for example, an acceleration sensor, a gyro sensor, and the like, for detecting acceleration in the three directions of X-axis, Y-axis, and Z-axis and an angular velocity in the three axes of yaw, pitch and roll.

The nonvolatile memory 23 stores therein various items of data acquired during flight. The data includes images, position data, posture data, and the like, for example.

The drone 2 may further include a mirror (not illustrated). The mirror is arranged such that the image capture device 24 can capture objects in the mirror. The posture control device 26 may control both an angle of the image capture device 24 and an angle of the mirror. Additional use of the mirror achieves easily acquiring images of the regions (such as bottom and side of a bridge) which are difficult to capture only by controlling a posture of the drone 2 and a posture of the image capture device 24.

FIG. 4 illustrates a system configuration of the image capture device 24. The image capture device 24 has a function of acquiring images and processing the acquired images.

As illustrated in FIG. 4, the image capture device 24 includes, for example, a filter 41, a lens 42, an image sensor 43, a processing unit, a storage unit, and the like. A processing circuit such as a CPU 44 constitutes the processing unit. Various storage mediums such as RAM 45 and nonvolatile memory 46 constitute the storage unit. The image capture device 24 may further include a memory card slot 47 and a communication device 48. A bus 40 may connect the image sensor 43, the CPU 44, the RAM 45, the memory card slot 47, the communication device 48, and the nonvolatile memory 46 each other, for example.

The image sensor 43 receives light passing through the filter 41 and the lens 42, and converts (photoelectrically converts) the received light into an electric signal to generate an image. The image sensor 43 generates an image which includes pixels. Each of the pixels contains at least one color component. As the image sensor 43, for example, a charge coupled device (CCD) or a complementary metal oxide semiconductor (CMOS) is used. The image sensor 43 includes, for example, imaging elements which receive a red (R) light, imaging elements which receive a green (G) light, and imaging elements which receive a blue (B) light. Each imaging element receives the light of the corresponding wavelength band, and converts the received light into an electric signal. A/D converting the electric signal can generate a color image. In the following, an R component, a G component, and a B component of the image may be referred to as an R image, a C image, and a B image, respectively. Further, the R image, the G image, and the B image can be generated using the electric signals of the red, green, and blue imaging elements, respectively.

The CPU 44 controls the operations of various components in the image capture device 24. The CPU 44 executes various programs loaded from the nonvolatile memory 46 as storage device into the RAM 45. The nonvolatile memory 46 can store images generated by the image sensor 43 or processing results of the images.

Various removable storage mediums such as an SD memory card or an SDHC memory card can be inserted into the memory card slot 47. When inserting a storage medium into the memory card slot 47, data may be written to and read from the storage medium. The data includes, for example, image data or distance data.

The communication device 48 is an interface device configured to perform a wired communication or a wireless communication. The communication device 48 includes a transmitter transmitting a signal in a wired or wireless manner and a receiver receiving a signal in a wired or wireless manner.

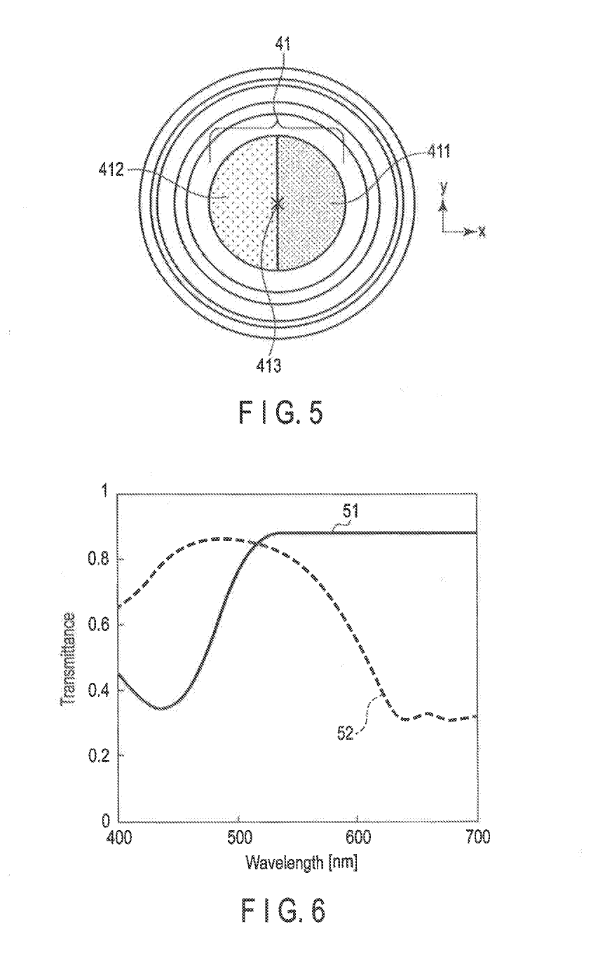

FIG. 5 illustrates an exemplary configuration of the filter 41. Two color filter regions such as a first filter region 411 and a second filter region 412 constitute the filter 41, for example. The center of the filter 41 matches with an optical center (optical axis) 413 of the image capture device 24. The first filter region 411 and the second filter region 412 each have a non-point-symmetric shape with respect to the optical center 413. For example, the filter region 411 does not overlap with the filter region 412, and these two filter regions 411 and 412 form the entire region of the filter 41. In the example illustrated in FIG. 5, the first filter region 411 and the second filter region 412 have a semicircular shape in which the circular filter 41 is divided by a segment passing through the optical center 413. The first filter region 411 is, for example, a yellow filter region and the second filter region 412 is, for example, a cyan (C) filter region.

The filter 41 includes two or more color filter regions. The color filter regions each have a non-point-symmetric shape with respect to the optical center of the image capture device 24. Part of the wavelength band of a light transmitting a color filter region overlaps with part of the wavelength band of a light transmitting another color filter region, for example. The wavelength band of a light transmitting a color filter region may include, for example, a wavelength hand of a light transmitting another color filter region.

The first filter region 411 and the second filter region 412 may be a filter changing a transmittance of an arbitrary wavelength band, a polarization filter passing a polarized light in an arbitrary direction, or a microlens changing a focusing power of an arbitrary wavelength band. For example, the filter changing a transmittance of an arbitrary wavelength band may be a primary color filter (RGB), a complementary color filter (CMY), a color compensating filter (CC-RGB/CMY), an infrared/ultraviolet cutoff filter, a ND filter, or a shielding plate. When the first filter region 411 and the second filter region 412 are microlenses, a distribution of focused light e rays is deviated by the lens 42, and thus a blur shape changes.

In the following, a case where the first filter region 411 is a yellow (Y) filter region and the second filter region 412 is a cyan (C) filter region in the filter 41 in FIG. 5 will be exemplified in order to help with understanding.

When the filter 41 is disposed in an aperture of the camera, a structured aperture of which the aperture is divided into two color parts constitutes a color-filtered aperture. The image sensor 43 generates an image based on light rays transmitting the color-filtered aperture. The lens 42 may be disposed between the filter 41 and the image sensor 43 on an optical path through which the light is incident into the image sensor 43. The filter 41 may be disposed between the lens 42 and the image sensor 43 on the optical path through which the light is incident into the image sensor 43. When multiple lenses 42 are provided, the filter 41 may be disposed between two lenses 42.

More specifically, a light with a wavelength band corresponding to the imaging elements configured to receive a green (G) light in the image sensor 43 transmits both the first filter region 411 of yellow and the second filter region 412 of cyan. A light of a wavelength band corresponding to the imaging elements configured to receive a red (R) light in the image sensor 43 transmits the first filter region 411 of yellow but does not transmit the second filter region 412 of cyan. A light with a wavelength band corresponding to the imaging elements configured to receive a blue (B) light in the image sensor 43 transmits the second filter region 412 of cyan but does not transmit the first filter region 411 of yellow.

Transmitting a light of a certain wavelength hand through a filter or a filter region means transmitting (passing) the light with the wavelength band through the filter or a filter region at high transmittance. This means that attenuation of the light (or a reduction of the amount of light) of the wavelength band due to the filter or the filter region is extremely small. Not transmitting a light of a certain wavelength band through a filter or a filter region means shielding a light by the filter or the filter region, for example, transmitting the light of the wavelength band through the filter or the filter region at a low transmittance. This means that the attenuation of the light of the wavelength band due to the filter or the filter region is extremely large. The filter or the filter region attenuates the light by, for example, absorbing the light of a certain wavelength band.

FIG. 6 illustrates an example of transmittance characteristics of the first filter region 411 and the second filter region 412. The transmittance to the light of a wavelength longer than 700 nm in a visible light wavelength band is not illustrated, but the transmittance is near to the case of 700 nm. In the transmittance characteristic 51 of the first filter region 411 of yellow in FIG. 6, the light corresponding to the R image having a wavelength band of about 620 nm to 750 nm and the G image having a wavelength band of about 495 nm to 570 nm is transmitted at a high transmittance, and most of the light corresponding to the B image of a wavelength band of about 450 nm to 495 nm is not transmitted. In a transmittance characteristic 52 of the second filter region 412 of cyan, the light of the wavelength band corresponding to the B and G images is transmitted at a high transmittance, and most of the light of the wavelength band corresponding to the R image is not transmitted.

Therefore, the light of the wavelength band corresponding to the R image transmits only the first filter region 411 of yellow, and the light of the wavelength band corresponding to the B image transmit s only the second, filter region 412 of cyan.

The blur shapes on the R image and the B image change depending on a distance (or a depth) d to the object. Each of the filter regions 411 and 412 has a non-point-symmetric shape with respect to the optical center 413. Therefore, the directions of blur deviation on the R and B images are inverted according to whether the object is on the near side or on the deep side from a focus position when viewed from an image capture point. The focus position is a point away from the image capture point by a focus distance d_{f}, and is a focused position at which the blur does not occur on the image captured by the image capture device 24.

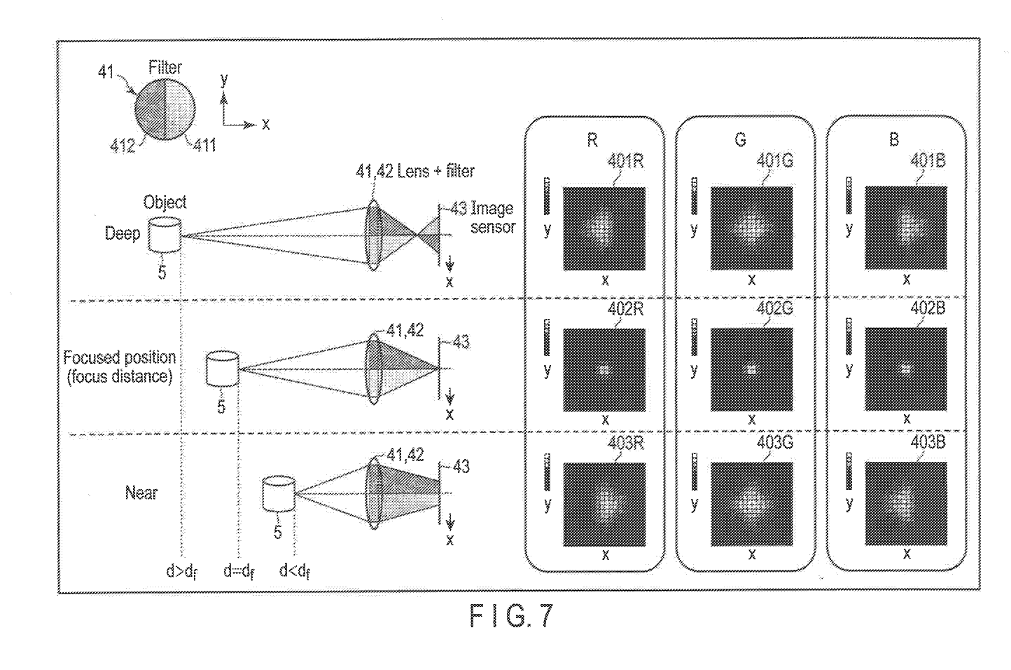

The description will be given about a change of the light rays and the blur shape due to the color-filtered aperture where the filter 41 is disposed, with reference to FIG. 7.

When an object 5 is on the deep side from the focus distance d_{f} (focused position) (d>d_{f}), blur occurs in an image captured by the image sensor 43. A blur function indicating a shape of blur on the image is different among the R image, the G image, and the B image. That is, a blur function 401R of the B image indicates the blur shape deviated to the left side, a blur function 401G of the G image indicates the blur shape without deviation, and a blur function 401B of the B image indicates the blur shape deviated to the right side.

When the object 5 is at the focus distance d_{f} (d=d_{f}), blur almost does not occur on an image captured by the image sensor 43. A blur function indicating a shape of blur on the image is almost the same among the R image, the G image, and the B image. That is, a blur function 402R of the R image, a blur function 402G of the G image, and a blur function 402B of the B image indicate blur shapes without deviation.

When the object 5 is on the near side from the focus distance d_{f} (d<d_{f}), blur occurs in an image captured by the image sensor 43. A blur function indicating a shape of blur on the image is different among the R image, the G image, and the B image. That is, a blur function 403R of the R image indicates the blur shape deviated to the right side, a blur function 403G of the G image indicates the blur shape without deviation, and a blur function 403B of the B image indicates the blur shape deviated to the left side.

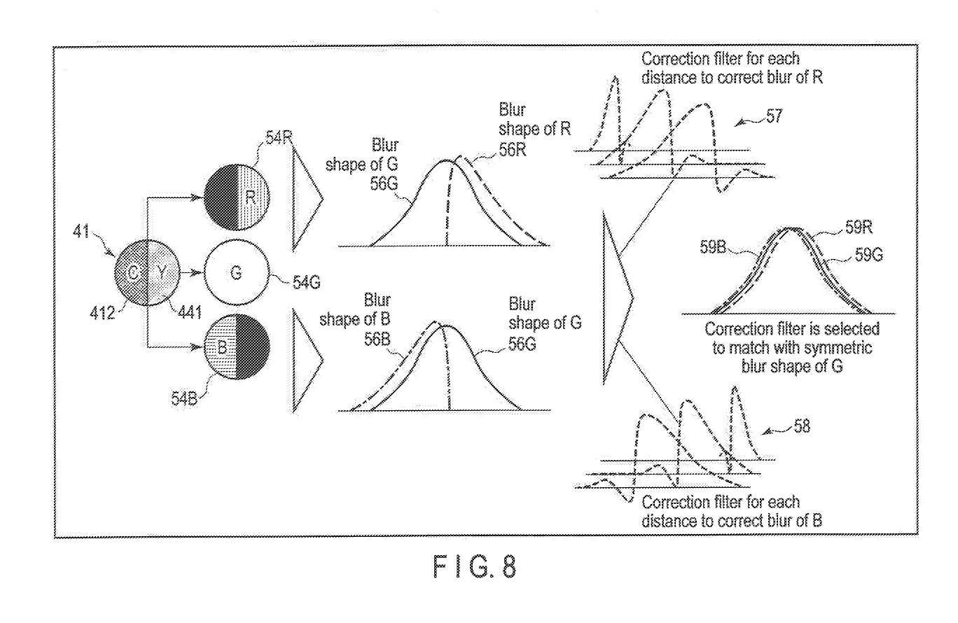

FIG. 8 illustrates a method of using blur on an image to calculate a distance to the object 5. In the example illustrated in FIG. 8, the first filter region 411 of yellow and the second filter region 412 of cyan constitute the filter 41. Thus, the light of the wavelength band corresponding to the R image passes through a portion 54R corresponding to the first filter region 411, the light with the wavelength band corresponding to the G image passes through a portion 54G corresponding to the first filter region 411 and the second filter region 412, and the light with the wavelength band corresponding to the B image passes through a portion 54B corresponding to the second filter region 412.

When blur occurs on an image captured using the filter 41, a different shape of blur occurs on the R image, the G image, and the B image, respectively. As illustrated in FIG. 8, a blur function 56G of the G image indicates a point-symmetric shape of blur. A blur function 56R of the R image and a blur function 56B of the B image indicate a non-point-symmetric shape of blur, and are different in the deviation of blur.

Blur correction filters 57 and 58 configured to correct non-point-symmetric blur on the R image and the B image into point-symmetric blur based on blur estimated per distance to en object are applied to the blur function 56R of the R image and the blur function 56B of the B image. Then, a determination is made as to whether the blur functions 56R and 56B match with the blur function 56G of the G image. A plurality of blur correction filters corresponding to a plurality of distances are prepared as the blur correction filters 57 and 58 per distance, at a specific interval. When a blur function 59R applied with the blur correction filter 57 or a blur function 59B applied with the blur correction filter 58 matches with the blur function 56G of the G image, the distances corresponding to the blur correction filters 57 or 58 is determined as the distance to the captured object 5.

Determining whether a blur function matches with another blur function can employ a correlation between the R image or B image applied with the blue correction filter and the G image. Therefore, for example, retrieving a blur correction filter, for which a correlation between the R image or B image applied with the blur correction filter and the G image is higher, from among the blur correction filters achieves estimating a distance to the object captured in each pixel on the image. That is, a corrected image obtained by correcting a blur shape of the R or B image is generated using the plurality of blur correction filters created on an assumption that the distance to the object shown in the image is arbitrary, and a distance at which the correlation between the generated corrected image and the G image is higher is found. Therefore, the distance to the object can be calculated.

Calculating a correlation value indicating a correlation between the R image or B image applied with the blur correction filter and the G image may use, for example, a normalized cross-correlation (NCC), a zero-mean normalized cross-correlation (ZNCC), a color alignment measure, or the like.

Determining whether the blur function 59R or 59B applied with the blur correction filter 57 or 58 matches with the blur function 56G of the G image may use a difference degree between the R image or the B image applied with the blur correction filer and the G image. A distance with the lower difference degree is found thereby to calculate a distance to the object. Calculating the difference degree may use, for example, a sum of squared difference (SSD), a sum of absolute difference (SAD), or the like.

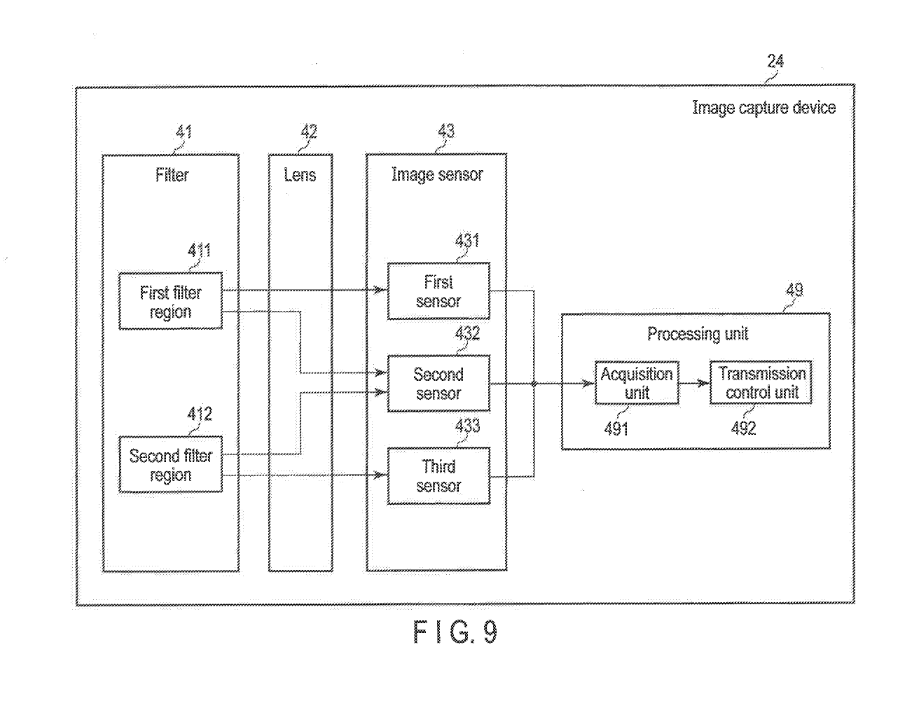

An example of a functional configuration of the image capture device 24 will be described with reference to FIG. 9. As described above, the image capture device 24 includes the filter 41, the lens 42, and the image sensor 43. Each arrow from the filter 41 to the image sensor 43 indicates a path of a light. The filter 41 includes the first filter region 411 and the second filter region 412. The first filter region 411 is, for example, a filter region of yellow. The second filter region 412 is, for example, a filter region of cyan. The image sensor 43 includes a first sensor 431, a second sensor 432, and a third sensor 433. The first sensor 431 includes, for example, imaging elements that receive a red (R) light. The second sensor 432 includes, for example, imaging elements that receive a green (G) light. The third sensor 433 includes, for example, imaging elements that receive a blue (B) light. The image sensor 43 generates an image using the electric signal obtained by photoelectrically converting the received light. The generated image may include R component, G component, and B component, or may be three images an R image, a G image and a B image.

The image capture device 24 further includes a processing unit 49. Each arrow from the image sensor 43 to the processing unit 49 indicates a path of an electric signal. Hardware (circuit), software (program) executed by the CPU 44, or a combination of software and hardware may realize the respective functional configurations in the image capture device 24 including the processing unit 49.

The processing unit 49 includes an acquisition unit 491 and a transmission control unit 492. The acquisition unit 491 and the transmission control unit 492 acquire images captured during flight of the drone 2, and transmit the acquired images to the route generation apparatus 1.

More specifically, the acquisition unit 491 acquires images generated by the image sensor 43. The acquisition unit 491 acquires an image of a first color component (a first wavelength component) that has a non-point-symmetric blur function and captures a first object, and an image of a second color component (a second wavelength component) that has a point-symmetric blur function and captures the first object, for example. The first color component is, for example, R component or B component and the second color component is, for example, G component. The acquisition unit 491 may acquire, for example, an image including pixels each having at least one color component. In this image, blur does not occur in a pixel for which the distance to the object is the focus distance, and blur occurs in a pixel for which the distance to the object is not the focus distance. Further, the blur function indicating blur of the first color component of the pixels is non-point-symmetrical. An image and a depth image (depth map) are acquired by a single optical system that can generate an image that includes a first wavelength component having a non-point-symmetric blur function and a second wavelength component having a point-symmetric blur function.

The transmission control unit 492 transmits an image to the route generation apparatus 1 via the wireless communication device 27 in the drone 2. The transmission control unit 492 may transmit an image to the route generation apparatus 1 via the communication device 48.

The processing unit 49 may further have a function of calculating a distance to an object per pixel based on blur on an image as described above with reference to FIGS. 7 and 8. In this case, a depth image including a distance (depth) to the object per pixel can be transmitted to the route generation apparatus 1. This depth image is acquired together with an image at one image capture by a single imaging optical system. For example, the image capture device 24 having a color-filtered aperture can acquire a depth image together with an image (for example, a color image) from an image that is captured at one image capture by a single imaging optical system including the lens 42 and the image sensor 43.

A method for acquiring a distance to an object is not limited to the method that uses blur on an image, and may use any sensor or method. For example, the drone 2 is provided with a stereo camera, an infrared depth sensor, an ultrasonic sensor, a millimeter-wave radar, or a light detection and ranging (LiDAR) thereby to acquire a distance to an object. A distance to an object may be acquired in a method based on image analysis such as structure from motion (SfM).

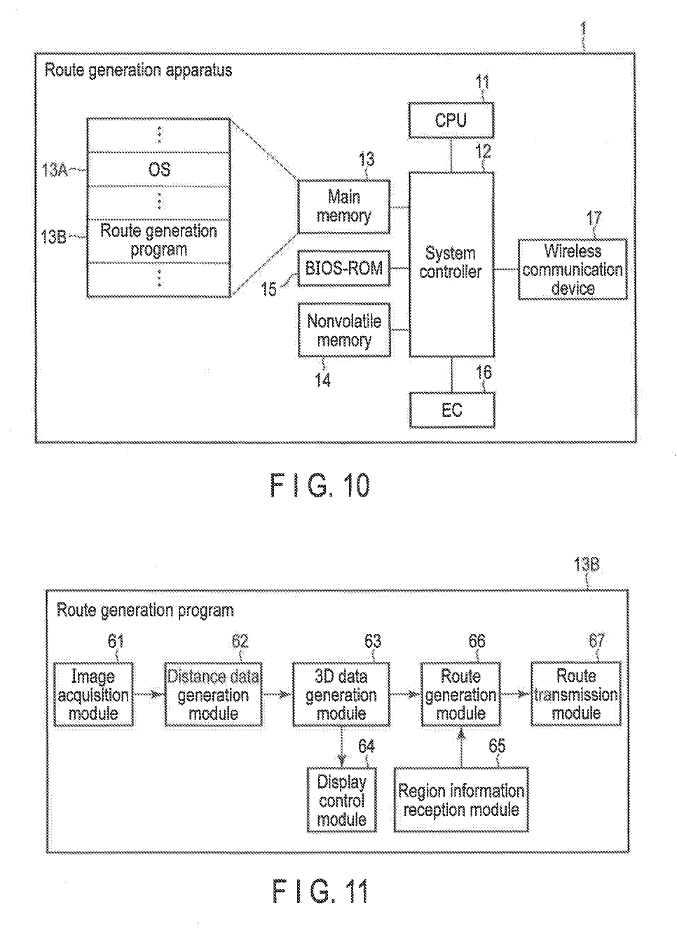

FIG. 10 illustrates a system configuration of the route generation apparatus 1. The route generation apparatus 1 includes a CPU 11, a system controller 12, a main memory 13, a nonvolatile memory 14, a BIOS-ROM 15, an embedded controller (EC) 16, a wireless communication device 17, and the like.

The CPU 11 is a processor that controls the operations of various components in the route generation apparatus 1. The CPU 11 executes various programs loaded from the nonvolatile memory 14 used as storage device into the main memory 13. The programs include an operating system (OS) 13A and various application programs. The application programs include a route generation program 13E. The route generation program 13B includes instructions for generating route data indicating a flight route of the drone 2.

The CPU 11 executes a basic I/O system (BIOS) stored in the BIOS-ROM 15. The BIOS is a program for hardware control.

The system controller 12 is a device that connects a local bus of the CPU 11 and various components. The system controller 12 incorporates therein a memory controller that controls access to the main memory 13.

The wireless communication device 17 is configured to perform wireless communication. The wireless communication device 17 includes a transmitter that wirelessly transmits a signal and a receiver that wirelessly receives a signal. The EC 16 is a one-chip microcomputer including an embedded controller for power management. The EC 16 has a function of powering on or off the route generation apparatus 1 in response to a user operation of the power button.

FIG. 11 illustrates a functional configuration of the route generation program 13B. The route generation program 13B includes an image acquisition module 61, a distance data generation module 62, a 3D data generation module 63, a display control module 64, a region information reception module 65, a route generation module 66, and a route transmission module 67.

The image acquisition module 61 and the distance data generation module 62 acquire a depth image capturing a first object. The image acquisition module 61 and the distance data generation module 62 acquire a depth image including distances (depths) from a first point to points on the first object to be checked. More specifically, the image acquisition module 61 acquires images of the first object captured from the drone 2 via the wireless communication device 17. The images are acquired by using the image capture device 24 in which the filter 41 including the first filter region 411 and the second filter region 412 is disposed on the aperture of the camera, for example. Thus, as described above with reference to FIGS. 7 and 8, a distance from the first point as a position of the image capture device 24 when capturing to the object (for example, a point on the object corresponding to a pixel in the image) can be calculated per pixel based on blur on the image. The distance data generation module 62 generates a depth it including the distances to the object per pixel based on the blur on the acquired image. The depth image includes distance data corresponding to each pixel on the acquired image (original image).

The 3D data generation module 63 generates 3D data by using the generated depth image. The 3D data generation module 63 generates 3D data indicating a 3D position per pixel in the camera coordinate system based on, for example, internal parameters of the camera as the image capture device 24. The 3D data generation module 63 may generate 3D data by using not only the depth image but also the pixel values (for example, luminance values, RGB values or the like) of the original image. The 3D data generation module 63 may generate 3D data indicating a 3D position per pixel in the GPS coordinate system by additional use of position/posture data of the camera at a time of capturing. The position/posture data is acquired by using the GPS receiver 28 and the inertia sensor 23 in the drone 2.

The 3D data generation module 63 generates mesh data indicating planes (polygons) configuring a 3D model of the object by clustering points in the 3D data and assigning a region including similar points to one mesh by using the original image and the depth image. The 3D data generation module 63 assigns two points with similar colors (two points for which a difference between pixel values indicating colors is less than a threshold, for example) to the same mesh and assigns two points with different colors (points for which a difference between pixel values indicating colors is the threshold or more) to different meshes, based on the color of each point. When an edge is present between two regions each including points, the 3D data generation module 63 assigns the points included in the two regions to different meshes. The 3D data may include the mesh data.

The 3D data generation module 63 may further generate projection data indicating a projection image obtained by projecting each point indicated in the 3D data on the horizontal plane (x-y plane).

The display control module 64 transmits a display signal for displaying the generated 3D data or projection data to the tablet computer 3 via the wireless communication device 17. Thereby, the display control module 64 causes the tablet computer 3 to display the 3D model based on the 3D data or the projection image based on the projection data on the screen of the tablet computer 3.

The region information reception module 65 receives first region information for specifying a first region including at least part of a first object based on 3D data from the tablet computer 3. The region information reception module 65 receives, for example, first region information for specifying a first region that includes part of a 3D model based on 3D data or second region information for specifying a second region that includes part of a projection image based on projection data. The first region information may be expressed by using projection data obtained by projecting the 3D data on a horizontal plane. A specified region indicates a region on the 3D model or the projection image for which the user wants to acquire more images for checking the first object.

The display control module 64 may send a display signal based on the 3D data or the projection data to not the tablet computer 3 but a touch screen display (not illustrated) connected to the route generation apparatus 1, and may cause the touch screen display to display the 3D model or the projection image on the screen of the touch screen display. In this case, the region information reception module 65 may receive the first region information for specifying the first region that includes part of the 3D model based on the 3D data or the second region information for specifying the second region that includes part of the projection image based on the projection data via the touch screen display.

When receiving the first region information, the route generation module 66 generates route data indicating a flight route for capturing the first region (that is, a region on the first object corresponding to the first region) by using the first region information and the 3D data. The route generation module 66 determines a flight route such that a value of the cost function based on flight distance and the number of times of direction change (turning) of the drone 2 is minimized by using a size (such as width and depth) of the region on the first object corresponding to the first region, for example. The size of the region on the first object corresponding to the first region can be calculated by using the 3D data. Power supplied from the battery drives the drone 2, and thus time of one flight is limited. Therefore, the route generation module 66 uses the cost function capable of determining a flight route with low power consumption of the drone 2.

The route generation module 66 uses the cost function for placing different weights on a flight distance in vertical movement such as rise and fall and on a flight distance in horizontal movement. The route generation module 66 places a large weight on the flight distance in vertical movement and places a small weight on the flight distance in horizontal movement. Thereby, a flight route can be determined such that the flight distance in vertical movement with high power consumption of the drone 2 is short. When the region on the first object corresponding to the first region is rectangular, for example, the route generation module 66 can reduce the number of times of direction change by determining a flight route preferentially along the long side of the rectangular region.

When receiving the second region information in which the second region on the projection image is specified, the route generation module 66 generates route data indicating a flight route for capturing the region on the first object corresponding to the second region by using the second region information. More specifically, the route generation module 66 determines a region on the 3D model corresponding to the second region. The route generation module 66 then generates route data indicating a flight route for capturing the region on the first object corresponding to the determined region on the 3D model as in receiving the first region information.

The route generation module 66 may extract a region with specific characteristics on the first object by using an original image, a depth image, and/or 3D data, and may generate route data indicating a flight route for acquiring images focusing on the extracted region. The flight route for acquiring such images may be set to be temporarily deviated from the flight route with the minimum cost function. The route generation module 66 may generate route data that defines a distance to the first object during flight based on a resolution of the image capture device 24 used for capturing (resolution used for capturing the first region, for example) and a size of the region with specific characteristics on the first object. The region with specific characteristics includes an abnormal part such as crack, damage or distortion, or a part attached with a predetermined member such as screw or nut. The route generation module 66 generates route data such that a distance to the first object is short when a region with a small abnormal part is captured and a distance to the first object is long when a region with a large abnormal part is captured. That is, the route generation module 66 can generate route data such that the drone 2 is close to the first object in order to capture a region with a small abnormal part and away from the first object in order to capture a region with a large abnormal part.

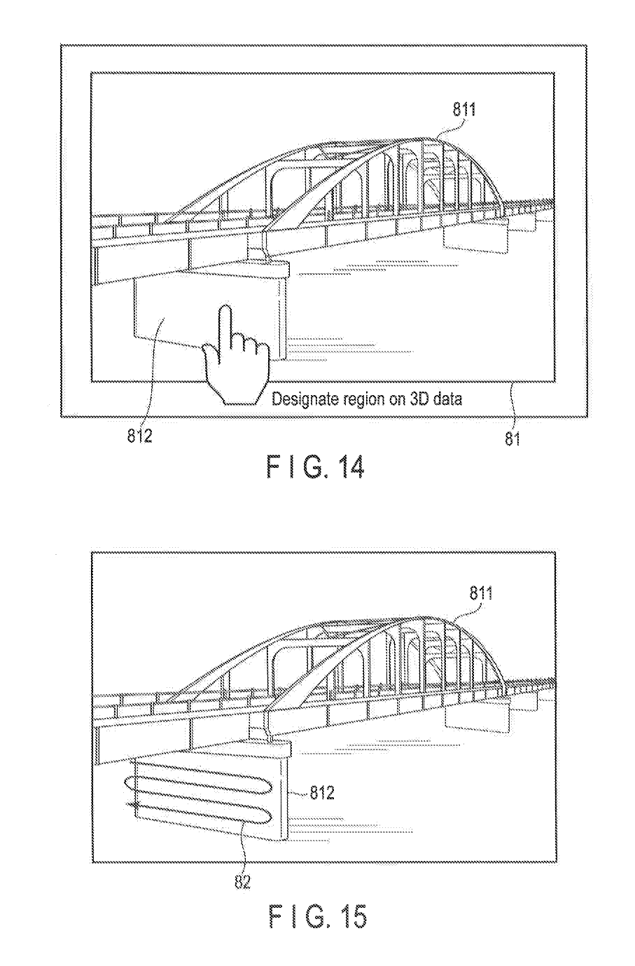

The route data may include not only the positions of the respective points on the flight route but also any parameters for flight and capturing such as posture and speed of the drone 2 at each point, and posture, resolution, and degree of zooming-in/out of the image capture device 24 attached on the drone 2. A position may be expressed by latitude, longitude and altitude, and a posture may be expressed by angles such as yaw, pitch and roll. A specific example to determine a flight route will be described below with reference to FIGS. 14 to 17.

When drones 2 on which the image capture device 24 is attached at a different position are used, the route generation module 66 may select one or more drones 2 used for capturing and generate route data of the selected drones 2 based on the orientations of planes configuring a region to be captured. When a horizontal plane is captured from below, the route generation module 66 selects a drone 2 on which the image capture device 24 is attached on top of the main body 20. When a vertical plane is captured, the route generation module 66 selects a drone 2 on which the image capture dice 24 is attached at the side of the main body 20. Thereby, a region of interest can be captured without complicated control of a posture of the drone 2.

The route transmission module 67 transmits the generated route data to the drone 2 via the wireless communication device 17. The drone 2 can acquire images of a user-designated region during the flight using the received route data.

The images acquired by using the image capture device 24 on the drone 2 may include not only the first object to be checked but also a second object. Thus, a depth image generated by the distance data generation module 62 may further include distances from the first point to points on the second object.

When the second object is not a target to be checked, the user can designate a region on a 3D model or projection image for which the user wants to acquire more images and can additionally designate a region that the drone 2 is prohibited from approaching. The region that the drone 2 is prohibited from approaching includes a region not to be checked, a region in which the drone 2 is prohibited from flying or capturing, and a region endangering flight of the drone 2.

In this case, the region information reception module 65 receives from the tablet computer first region information for specifying a first region that includes part of a 3D model in order to designate a region for which the user wants to acquire more images, and third region information for specifying a third region that includes part of a depth image (for example, a third region that includes part of a 3D model) In order to designate a region that the drone 2 is prohibited from approaching. The route generation module 66 then generates route data indicating a flight route for capturing a region on the first object corresponding to the first region without entering the third region, by using the first region information and the third region information. The route data may indicate a flight route for capturing a region on the first object corresponding to the firs region without approaching the third region.

The region information reception module 65 may receive from the tablet computer 3, second region information for specifying a second region that includes part of a projection image in order to designate a region for which the user wants to acquire more images and fourth region information for specifying a fourth region that includes part of the projection image in order to designate a region that the drone 2 is prohibited from approaching. In this case, the route generation module 66 generates route data indicating a flight route for capturing a region on the first object corresponding to the second region and preventing a region on the second object corresponding to the fourth region from being approached, by using the second region information and the fourth region information.

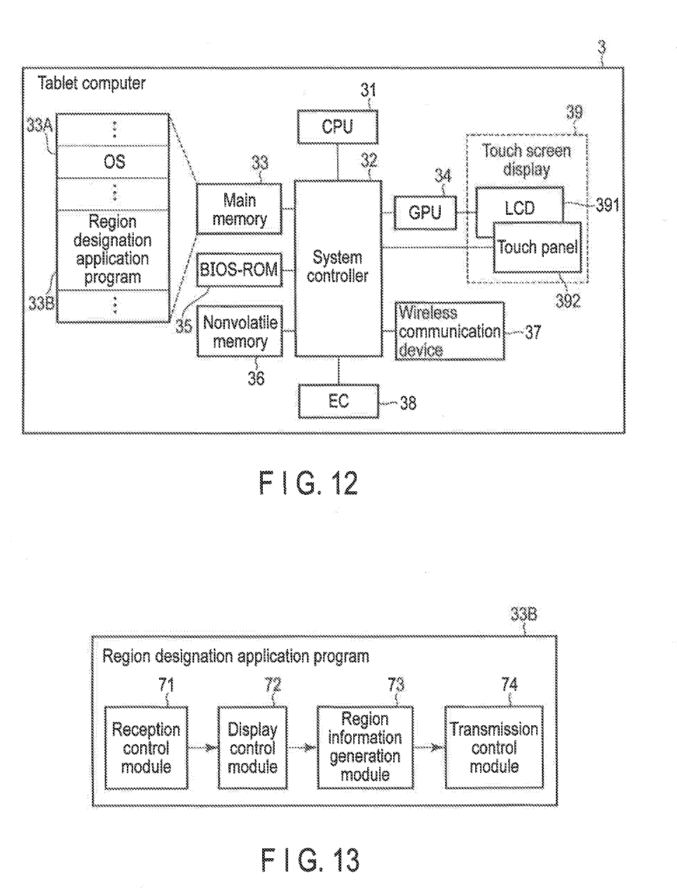

FIG. 12 illustrates a system configuration of the tablet computer 3. The tablet computer 3 includes a CPU 31, a system controller 32, a main memory 33, a graphics processing unit (GPU) 34, a BIOS-ROM 35, a nonvolatile memory 36, a wireless communication device 37, an embedded controller (EC) 38, and the like.

The CPU 31 is a processor that controls the operations of various components in the tablet computer 3. The CPU 31 executes various programs loaded from the nonvolatile memory 36 used as a storage device into the main memory 33. The programs include an operating system (OS) 33A and various application programs. The application programs include a region designation application program 33B. The region designation application program 33B includes instructions displaying a 3D model based on 3D data or a projection image based on projection data and instructions for generating region information indicating a region designated on a 3D model or projection image.

The CPU 31 executes a basic I/O system (BIOS) stored in the BIOS-ROM 35. The BIOS is a program for hardware control.

The system controller 32 is a device that connects a local bus of the CPU 31 and various components. The system controller 32 incorporates therein a memory controller configured to control access to the main memory 33. The system controller 32 has a function of executing communication with the graphics processing unit (GPU) 34 via a serial bus of the PCI EXPRESS standard or the like.

The GPU 34 is a display processor configured to control an LCD 391 used as a display monitor of the tablet computer 3. A display signal generated by the GPU 34 is sent the LCD 391. The LCD 391 displays a screen image based on the display signal. A touch panel 392 is arranged on the top surface of the LCD 391. The touch panel 392 is a capacitance pointing device configured to input on the screen of the LCD 391. The touch panel 392 detects a contacted position on the screen at which a finger is contacted and motions of the contacted position.

The wireless communication device 37 is configured to perform a wireless communication. The wireless communication device 37 includes a transmitter that wirelessly transmits a signal and a receiver that wirelessly receives a signal. The EC 38 is a one-chip microcomputer including an embedded controller for power management. The EC 38 has a function of powering on or off the tablet computer 3 in response to a user operation of the power button.

FIG. 13 illustrates a functional configuration of the region designation application program 33B. The region designation application program 33B includes a reception control module 71, a display control module 72, a region information generation module 73, and a transmission control module 74. The CPU 31 executes instructions included in the region designation application program 33B so that the operations of the modules 71, 72, 73, and 74 described below are realized.

The reception control module 71 receives 3D data from the route generation apparatus 1 by using the wireless communication device 37. The 3D data includes data on a 3D model indicating an object to be checked. The 3D data may include mesh data of the 3D model.

The display control module 72 displays the 3D model on the screen of the touch screen display 39 by using the 3D data. The display control module 72 displays the 3D model as 3D mesh indicating regions (planes) configuring a 3D shape, for example. The user designates part of the displayed 3D model by an operation such as tap operation or slide operation) on the screen of the touch screen display 39 in order to designate a region whose images are acquired for checking.

The region information generation module 73 generates first region information of specifying a designated first region in accordance with a user operation (tap operation) for designating the first region that includes part of the 3D model. The region information generation module 73 detects, for example, a 3D region (3D mesh) including the user-tapped position as the user-designated first region, and generates the first region information indicating the first region. The first region information may be any form of information capable of specifying the designated region, such as 3D data corresponding to the designated region. The user can easily select part of the 3D model displayed on the screen of the touch screen display 39 in units of region (mesh) by a tap operation or the like.

The reception control module 71 may receive projection data from the route generation apparatus 1 by using the wireless, communication device 37. The projection data includes data obtained by projecting 3D data of a 3D model indicating an object to be checked on the horizontal plane (x-y plane).

The display control module 72 displays a projection image on the screen of the touch screen display 39 by using the projection data. The user designates part of the displayed projection image by an operation (such as tap operation or slide operation) on the screen of the touch screen display 39 in order to designate a region whose images are acquired for checking.

The region information generation module 73 generates second region information of specifying a designated second region in accordance with a user operation (slide operation) for designating the second region that includes part of the projection image. The region information generation module 73 detects a region including a position that corresponds to a slide operation by the user as the user-designated second region, and generates the second region information on the second region. The second region information may be any form of information capable of specifying the designated region, such as projection data corresponding to the designated region.

The transmission control module 74 transmits the generated first region information or second region information to the route generation apparatus 1 by using the wireless communication device 37. As described above, the route generation apparatus 1 generates route data on a flight route of the drone 2 by using the first region information or the second region information.

The display control module 72 may display the 3D model or the projection image moved, rotated, and enlarged/reduced in response to a user gesture operation (such as drag operation or pinch operation) by using the touch screen display 39. Thereby, the 3D model or the projection image is displayed in a user-recognizable manner so that the user can easily designate a region.

There will be described below examples in which a region on a 3D model or projection image is designated in the tablet computer 3 and a route of the drone 2 for acquiring images of the designated region is determined in the route generation apparatus 1 with reference to FIGS. 14 to 17.

FIG. 14 illustrates an example in which a region that includes part of a 3D model displayed on the screen is designated in the tablet computer 3. There will be illustrated herein an example in which a screen image 81 including a 3D model 811 of bridge is displayed on the touch screen display 39 provided in the tablet computer 3. The 3D model 811 is displayed as, for example, 3D mesh including regions configuring the 3D shape by using the 3D data transmitted from the route generation apparatus 1.

The user can designate a region that includes part of the 3D model 811 in order to specify a region whose images are acquired for checking by a tap operation or the like on the displayed 3D model 811. In the example of FIG. 14, based on a user tap operation, a region 812 of bridge pier including the tapped position on the 3D model 811 of bridge is designated. The region 812 of a bridge pier is detected as a user-designate region and region information for specifying the region 812 is generated. That is, region information for acquiring images of the region 812 of the bridge pier is generated.

As illustrated in FIG. 15, the route generation module 66 in the route generation apparatus 1 generates route data indicating a flight route 32 of the drone 2 based on the designated region 612 of the bridge pier. The route generation module 66 generates the route data on the flight route 82 capable of completely and efficiently acquiring images of the bridge pier corresponding to the designated region 812 in consideration of range (angle of view) captured by the image capture device 24, resolution, distance to the object (bridge pier), and the like. The route generation module 66 determines the flight route 82 for raster-scanning the bridge pier corresponding to the region 812, for example. The flight route 82 is set preferentially along the long side of the bridge pier, and for horizontal movement prior to vertical movement, thereby reducing the number of times of direction change and consumed power of the drone 2.

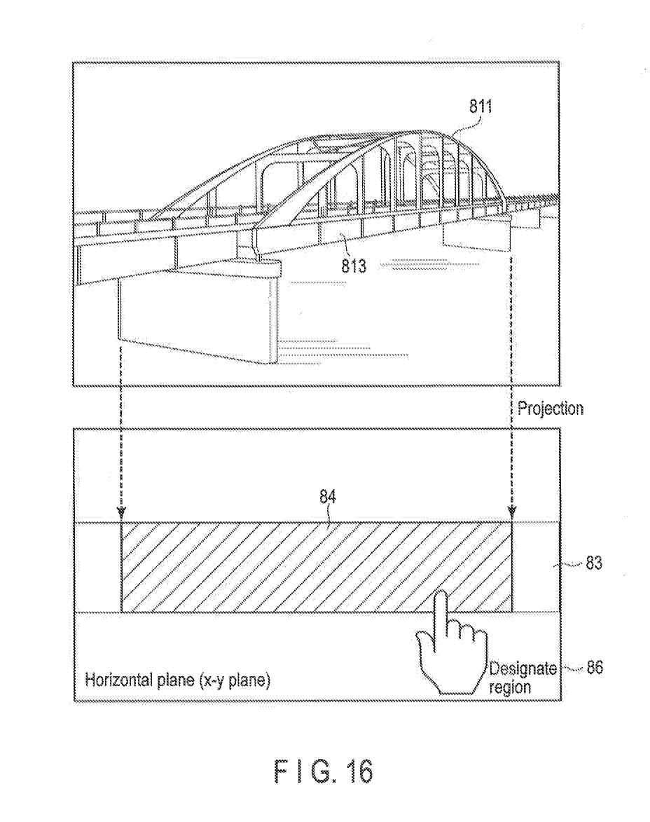

FIG. 16 illustrates an example in which a region including part of a projection image displayed on the screen is designated in the tablet computer 3. There will be described herein an example in which a screen image 86 including a projection image 83 of the 3D model 811 of bridge, is displayed on the touch screen display 39 provided in the tablet computer 3. The projection image 83 is obtained by projecting the 3D model 811 on the horizontal, plane (x-y plane).

The user can designate a region that includes part of the projection image 83 in order to specify a region whose images are acquired for checking by a slide operation or the like on the displayed projection image 83. In the example of FIG. 16, a region 84 including a user-designated position by a slide operation is designated. The region 84 is detected as a user-designated region, and region information for specifying the region 84 is generated.

The user may further designate images of either the top or the backside (bottom) of an actual region of the the bridge corresponding to the region 84 to acquire by using the graphical user interface (GUI) such as various buttons or a specific gesture operation. In this case, the region information includes the information for specifying the region 84 and the information on images of either the top or the backside to acquire. Thus, when the user designates the region 84 on the projection image 83 and instructs to acquire images from the backside, the region information including the information for specifying the region 84 and the information for acquiring the images of the backside is generated. That is, the region information for acquiring the images of the backside of a region 813 of the bridge girder corresponding to the region 84 on the projection image 83 is generated.

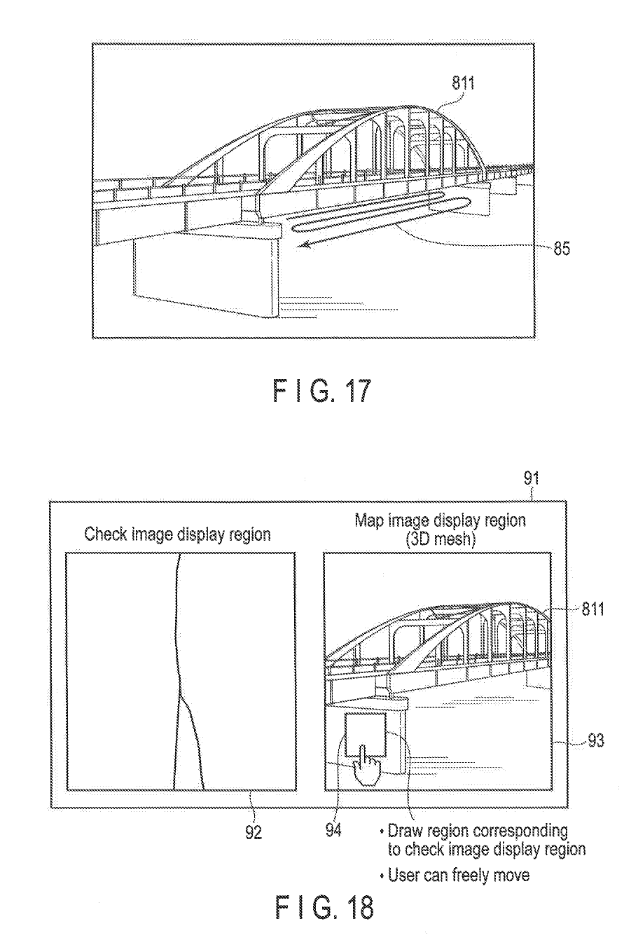

As illustrated in FIG. 17, the route generation module 66 in the route generation apparatus 1 generates route data on a flight route 85 of the drone 2 based on the information for specifying the region 84 and the information for acquiring the images of the backside. The route generation module 66 generates the route data on the flight route 85 capable of completely and efficiently acquiring images of the backside of the bridge girder corresponding to the designated region 84 in consideration of range (angle of view) captured by the image capture device 24, resolution, distance to the object (bridge girder), and the like. The route generation module 66 determines the flight route 85 for raster-scanning the backside of the bridge girder corresponding to the region 84, for example. The flight route 85 is set preferentially along the long side of the bridge girder and for horizontal movement prior to vertical movement, thereby reducing the number of times of direction change and consumed power of the drone 2.

Then, FIG. 18 illustrates an exemplary screen displayed on the tablet computer 3. The screen includes an image acquired by capturing during flight based on route data, and is, for example, a check screen 91 for checking an appearance of a construct (first object). The check screen 91 includes a check image display region 92 and a map image display region (3D mesh region) 93.

An image acquired by capturing during flight based on route data is drawn in the check image display region 92. The 3D model 811 of the object to be checked is drawn in the map image display region. 93. A region of interest 94 (for example, a rectangular region) corresponding to the check image display region 92 is illustrated in the map image display region 93. This indicates that the image drawn in the check image display region 92 is obtained by capturing the region of interest 94. The user can freely move the region of interest 94 by an operation on the touch screen display 39, thereby setting the region of interest 94 at any position in the map image display region 93 (for example, any position on the 3D model 811).

The user sets the region of interest 94 at the position of the bridge pier on the 3D model 811 of bridge in the map image display region 93, for example, so that an image captured for checking the bridge pier is displayed in the check image display region 92. The user can check crack or distortion of the bridge pier for example, when watching the image of the bridge pier displayed in the check image display region 92.

Moving images (video) acquired by capturing during flight based on route data may be played in the check image display region 92. The region of interest 94 may be drawn at a position on the map image display region 93 corresponding to the image drawn in the check image display region 92 in response to the playing.

An abnormality-detected part such as crack or distortion on the 3D model 811 may be previously indicated in a frame or a specific color to be distinguished from other parts, for example, in the map image display region 93.

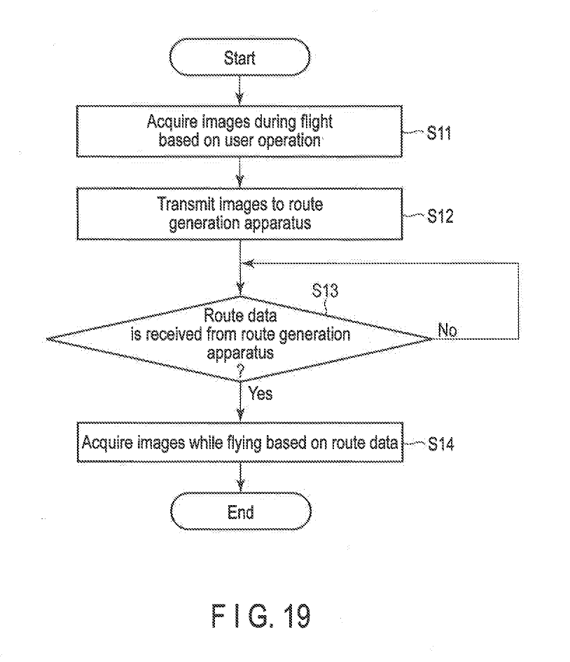

An example of the procedure of processing executed by the drone 2 will be described below with reference to the flowchart of FIG. 19.

At first the flight controller 21 in the drone 2 causes the drone 2 to fly under control of user operations, and the acquisition unit 491 in the image capture device 24 acquires images during the flight (step S11). The transmission control unit 492 then transmits the acquired images to the route generation apparatus 1 via the wireless communication device 27 (step S12). The acquisition unit 491 and the transmission control unit 492 may continuously acquire images during flight, and may transmit the acquired images to the route generation apparatus 1 at regular time interval, for example. The transmission control unit 492 may collectively transmit many acquired images to the route generation apparatus 1 after the end of flight and capturing. Thereby, the route generation apparatus 1 can acquire the images for creating a 3D model of a target object.

Then, the flight controller 21 determines whether it has received route data on a flight route from the route generation apparatus 1 (step S13). When the flight controller 21 has not received the route data (No in step S13), the flight controller 21 determines again whether it has received the route data by returning to step S13.

When having received the route data (Yes in step S13), the flight controller 21 causes the drone 2 to fly based on the flight route indicated in the route data, and the acquisition unit 491 in the image capture device 24 acquires an image (or images) during the flight (step S14). Thereby, images for checking the object can be acquired, for example. The transmission control unit 492 may transmit the acquired image to the route generation apparatus 1 and/or the tablet computer 3.

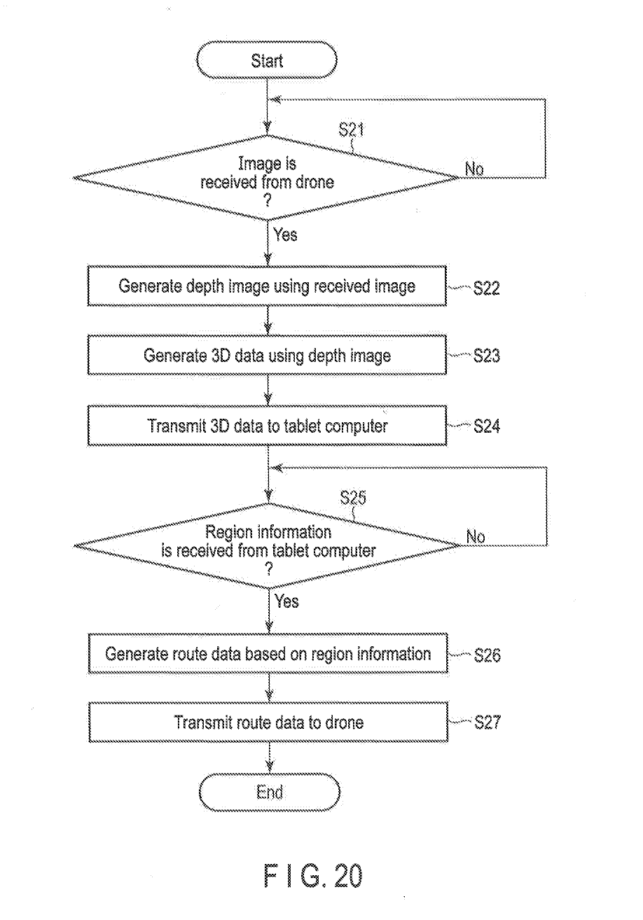

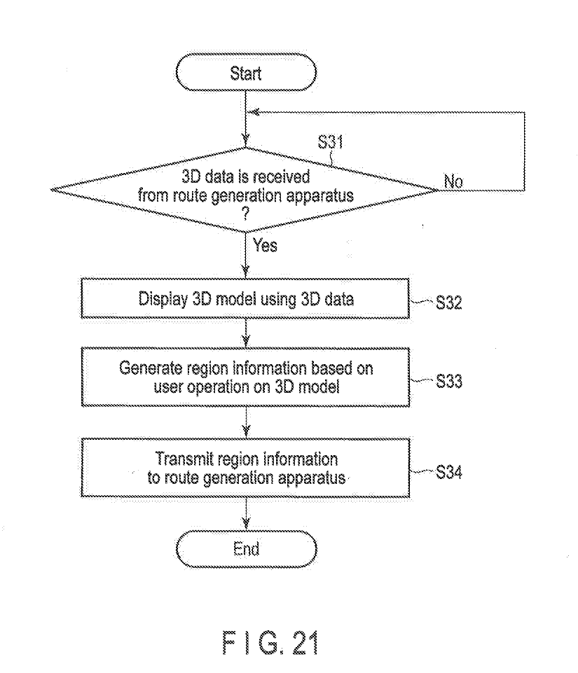

The flowchart of FIG. 20 indicates an example of the procedure of processing executed by the route generation apparatus 1. The procedure of the processing is realized as the functions of the respective modules in the route generation program 13B executed by the CPU 11 in the route generation apparatus 1, for example.

At first, the image acquisition module 61 determines whether it has received an image from the drone 2 via the wireless communication device 17 (step S21). When the image acquisition module 61 has not received the image from the drone 2 (No in step S21), the image acquisition module 61 determines again whether it has received the image from the drone 2 by returning to step S21.

When the image acquisition module 61 has received the image from the drone 2 (Yes in step S21), the distance data generation module 62 generates a depth image by using the image (step S22). The depth image includes distance data corresponding to each pixel on the original image. The 3D data generation module 63 generates 3D data by using the depth image (step S23). The display control module 64 then transmits the generated 3D data to the tablet computer 3 in order to display the 3D model on the screen of the tablet computer 3 (step S24).

The region information reception module 65 then determines whether it has received region information from the tablet computer 3 via the wireless communication device 17 (step S25). When the region information reception module 65 has not received the region information from the tablet computer 3 (No in step S25), the region information reception module 65 determines again whether it has received the region information from the tablet computer 3 by returning to step S25.

When the region information reception module 65 has received the region information from the tablet computer 3 (Yes in step S25), the route generation module 66 generates route data indicating a flight route of the drone 2 based on the received region information (step S26). The region information indicates a region on the 3D model corresponding to a region on the first object for which the user wants to acquire more images, for example. The route generation module 66 generates route data indicating a flight route for capturing the region on the first object. The route transmission module 67 transmits the generated route data to the drone 2 via the wireless communication device 17 (step S27).

The flowchart of FIG. 21 indicates an example of the procedure of processing executed by the tablet computer 3. The procedure of the processing is realized as the functions of the respective modules in the region designation application program 33B executed by the CPU 31 in the tablet computer 3, for example.

At first, the reception control module 71 determines whether it has received 3D data from the route generation apparatus 1 via the wireless communication device 37 (step S31). When the reception control module 71 has not received the 3D data (No in step S31), the reception control module 71 determines again whether it has received the 3D data from the route generation apparatus 1 by returning to step S31.

When the reception control module 71 has received the 3D data (Yes in step S31), the display control module 72 displays a 3D model on the screen of the LCD 391 by using the 3D data (step S32). The user designates a region that includes part of the displayed 3D model by using the touch panel 392, for example. The user designates a region for which he/she wants to acquire more images of the first object in order to check the first object presented as the 3D model, for example, by the operation. The region information generation module 73 generates region information in response to a user operation on the displayed 3D model (step S33). The region information includes 3D data corresponding to the user-designated region, for example. The transmission control module 74 transmits the generated region information to the route generation apparatus 1 via the wireless communication device 37 (step S34).

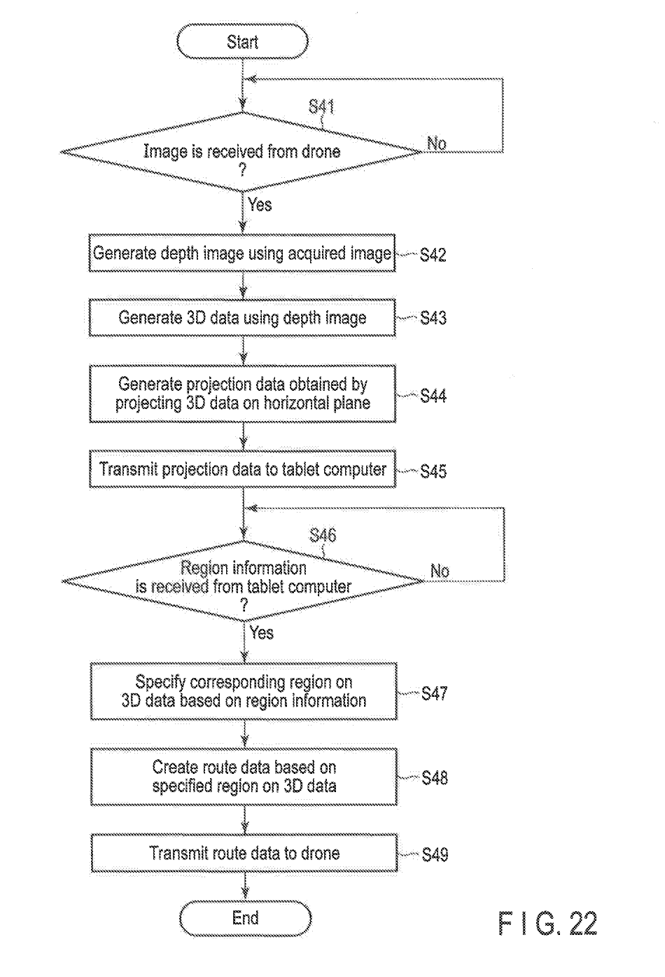

Then, the flowchart of FIG. 22 indicates another example of the procedure of processing executed by the route generation apparatus 1. The flowchart of FIG. 20 indicates an example of the procedure of processing when 3D data is transmitted from the route generation apparatus 1 to the table computer 3, while the flowchart of FIG. 22 indicates an example of the procedure of processing when projection data obtained by projecting 3D data on the horizontal plane is transmitted from the route generation apparatus 1 to the tablet computer 3.

The processing from step S41 to S43 is similar to the processing from step S21 to step S23 in FIG. 20.

After the processing in step S43, the 3D data generation module 63 generates projection data by projecting the generated 3D data on the horizontal plane (step S44). The projection data includes data indicative of a position on the horizontal plane on which the 3D data (3D position) is projected. The display control module 64 transmits the generated projection data to the tablet computer 3 in order to display a projection image on the screen of the tablet computer 3 (step S45).

The region information reception module 65 then determines whether it has received region information from the tablet computer 3 via the wireless communication device 17 (step S46). When the region information reception module 65 has not received the region information from the tablet computer 3 (No in step S46), the region information reception module 65 determines again whether it has received the region information from the tablet computer 3 by returning to step S46.

When the region information reception module 65 has received the region information from the tablet computer 3 (Yes in step S46), the route generation module 66 specifies a region on the 3D data corresponding to the region that includes part of the projection image based on the received region information (step S47). The route generation module 66 then generates route data on a flight route of the drone 2 based on the specified region on the 3D data (step S48). The region information indicates a region on the projection image corresponding to the region on the first object for which the user wants to acquire more images. The route generation module 66 generates route data on a flight route for capturing the region of the first object. The route transmission module 67 transmits the generated route data to the drone 2 via the wireless communication device 17 (step S49).

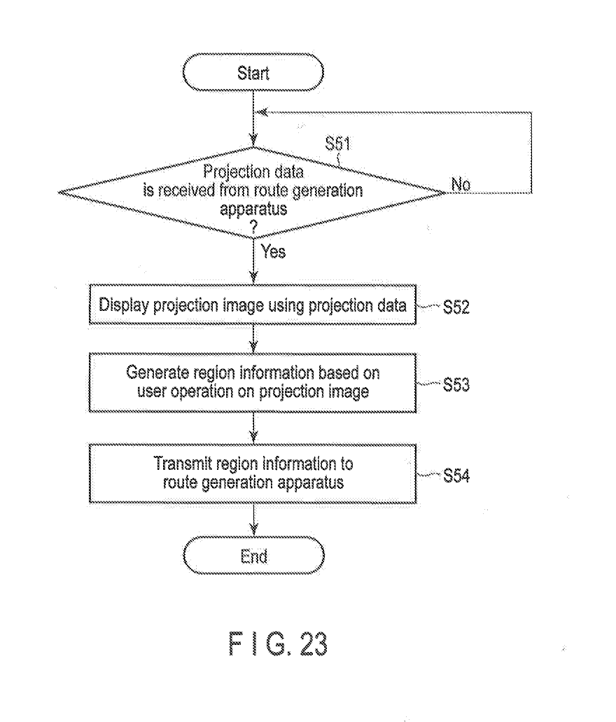

The flowchart of FIG. 23 indicates an example of the procedure of processing executed by the tablet computer 3 when projection data obtained by projecting 3D data on the horizontal plane is transmitted from the route generation apparatus 1 to the tablet computer 3.

At first, the reception control module 71 determines whether it has received projection data from the route generation apparatus 1 via the wireless communication device 37 (step S51). When the reception control module 71 has not received the projection data (No in step S51), the reception control module 71 determines again whether it has received the projection data from the route generation apparatus 1 by returning to step S51.

When the reception control module 71 has received the projection data (Yes in step S51), the display control module 72 displays a projection image on the screen of the LCD 391 by using the projection data (step S52). The user designates a region that includes part of the displayed projection image by using the touch panel 392, for example. The user designates a region for which he/she wants to acquire more images of the first object in order to check the first object presented as projection image, for example, by the operation. The region information generation module 73 generates region information based on a user operation on the displayed projection image (step S53). The region information includes projection data corresponding to the user-designated region, for example. The transmission control module 74 transmits the generated region information to the route generation apparatus 1 via the wireless communication device 37 (step S54).

As described above, it is possible to easily set a moving route of a moving object for capturing an object according to the present embodiment. The image acquisition module 61 in the route generation apparatus 1 acquires a depth image including distances from a first point to points on a first object. The distance data generation module 62 generates 3D data by using the depth image. The region information reception module 65 receives first region information for specifying a first region that includes part of a 3D model based on the 3D data. The route generation module 66 generates route data for capturing a region on the first object corresponding to the first region by using the first region information.

The drone 2 acquires images by using the image capture device 24 while traveling in a flight route based on the route data. Thereby, images of the region on the first object corresponding to the region designated on the 3D model can be acquired, thereby efficiently checking by using the acquired images.

### Second Embodiment

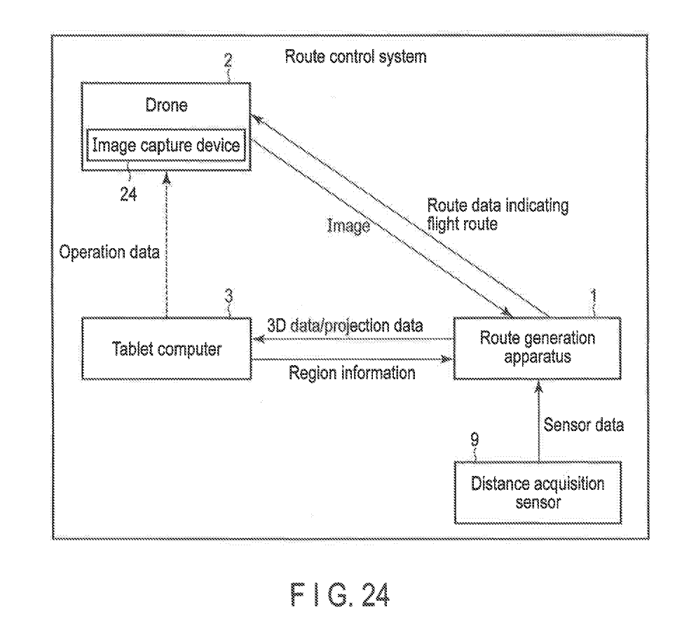

Next, a configuration of a route control system including a route generation apparatus according to a second embodiment will be described with reference to FIG. 24. The route control system of the present embodiment further includes a distance acquisition sensor 9 that acquires sensor data including a distance (depth), in addition to the route generation apparatus 1, the drone (moving object) 2 and the tablet computer 3 which are provided in the route control system of the first embodiment. The route generation apparatus 1, the drone (moving object) 2 and the tablet computer 3 have the configurations described above in the first embodiment. The distance acquisition sensor 9 is any sensor that can acquire a distance to an object. The distance acquisition sensor 9 may be realized, for example, as a distance sensor such as an infrared depth sensor, an ultrasonic sensor, a millimeter-wave radar or a LiDAR, or as a color-filtered aperture camera or a stereo camera that can acquire a distance to an object and an image of an object. For example, the color-filtered aperture camera has a configuration similar to that of the image capture device 24 of the first embodiment. As the distance acquisition sensor 9, a distance sensor and an image capture device may be used. In that case, the distance acquisition sensor 9 acquires a distance and an image.

As described above, the route generation apparatus 1 of the first embodiment acquires an image including information of a distance to an object by using the image capture device 24 provided in the drone 2, and generates 3D data or projection data of an object by using this image.

On the other hand, the route generation apparatus 1 of the second embodiment acquires information of a distance to an object, an image including distance information, or a depth image and an image (for example, a color image) by using the distance acquisition sensor 9, and generates 3D data or projection data of an object by using the distance information, the image including the distance information, or the depth image and the image. The distance acquisition sensor 9 may be mounted on a vehicle or a robot or may also be mounted on a drone other than the drone 2. Alternatively, the user may carry the distance acquisition sensor 9 to a position for sensing an object. The distance information, the image including the distance information, or the depth image and the image acquired by the distance acquisition sensor 9 may be transmitted (output) from the distance acquisition sensor 9 to the route generation apparatus 1 via data transmission over wired or wireless communication. Further, the data acquired by the distance acquisition sensor 9 may be stored in any storage medium such as an SD memory card, and by connecting the storage medium via a card slot (not shown), etc., provided in the route generation apparatus 1, the data may be imported into the route generation apparatus 1.

In the present embodiment, distance information (depth image) of a construct to be checked, etc., is acquired by the distance acquisition sensor 9. Further, the route generation apparatus 1 uses a 3D model or its projection image created by using the distance information for user's designation of a region including part of a construct. According to the user's designation, the route generation apparatus 1 automatically creates a moving plan of a moving object for acquiring an image of the designated region. For example, by simply acquiring the distance information using the distance acquisition sensor 9 and designating a region including part of the 3D model of the construct or its projection image created by using the distance information, in advance or at the check site, etc., the route generation apparatus 1 can automatically create route data indicating the moving route of the moving object for acquiring an image of a region on the actual construct corresponding to the designated region. Accordingly, human loads on the operation of the moving object, etc., can be reduced, and the moving route of the moving object for capturing be easily set. Further, the construct can be efficiently checked, etc., by using the image captured while the moving object moves based on the set moving route.

In FIG. 24, an image transmitted from the drone 2 to the route generation apparatus 1 is, for example, the image captured while the moving object moves based on the moving route. Therefore, the drone 2 of the present embodiment may be configured to perform the processes of steps S13 and S4 in the processing shown in the flowchart of FIG. 19. Further, the route generation apparatus 1 determines whether data (for example, a depth image (distance information), an image including distance information, or a depth image and an image) is received (acquired) not from the drone 2 but from the distance acquisition sensor 9 in the process of step S21 shown in the flowchart of FIG. 20 or in the process of step S41 shown in the flowchart of FIG. 22. Subsequently, if a depth image is acquired from the distance acquisition sensor 9, the route generation apparatus 1 can skip the process of step S22 or the process of step S42.

The configuration of the route generation apparatus 1 for generating route data using distance information can be easily realized by modifying such that a depth image (or an image and a depth image) acquired by the distance acquisition sensor 9 will be used in the configuration of the route generation program 13B described above with reference to FIG. 11. For example, a depth image (or an image and a depth image) acquired by the distance acquisition sensor 9 may be input to the 3D data generation module 63.

If the distance acquisition sensor 9 is, for example, a color-filtered aperture camera or a stereo camera, a captured image may be input to the image acquisition module 61, or an image and a depth image acquired by processing a capture image using a processor (not shown), etc., provided in the distance acquisition sensor 9 may be input to the 3D data generation module 63. If a captured image is input to the image acquisition module 61, the image acquisition module 61 and the distance data generation module 62 process the captured image and generate an image and a depth image, and output the image and the depth image to the 3D data generation module 63.

Further, if a moving object whose moving route is designed by the route, generation apparatus 1 is the drone 2 equipped with the image capture device 24 (for example, a color-filtered aperture camera), since the drone 2 can acquire distance information of a distance to an object during flight, the drone 2 can fly according to a route generated by the route generation apparatus 1 (for example, a route where a distance to an object is designated). Further, the drone 2 can acquire the width and the depth of a defective part such as a crack or a distortion of a bridge pier, etc., by acquiring distance information from a captured image.

Various functions described in the embodiments may be implemented by a processing circuit. Examples of the processing circuit include a programmed processor such as a central processing unit (CPU). The Processor realizes each of the described functions by executing a program (instructions) stored in a memory. The processor may be a microprocessor including an electronic circuit. Examples of the processing circuit also include a digital signal processor (DSP), an application-specific integrated circuit (ASIC), a microcontroller, a controller and other electronic circuit components. Each of the components other than the CPU described in the embodiments may also be implemented by a processing circuit.

Since each process of the embodiments can be implemented by a computer program, the same advantage as each of the embodiments can be easily achieved by loading the computer program into a general-purpose computer through a computer-readable storage medium that stores the computer program, and executing the computer program.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A route generation apparatus comprising:
a memory; and
a circuit coupled with the memory,
wherein the circuit is configured to:
acquire a depth image regarding a capturing object including a first object;
generate three-dimensional data by using the depth image;
receive first region information that specifies a first region including at least part of the first object based on the three-dimensional data; and
generate route data by using the first region information and the three-dimensional data.

2. The route generation apparatus of claim 1,
wherein the circuit is further configured to:
acquire an image comprising the first object; and
generate the three-dimensional data by using the depth image and the image.

3. The route generation apparatus of claim 1,
wherein the circuit is further configured to generate projection data obtained by projecting the three-dimensional data on a two-dimensional plane, and
the first region information is generated by using the projection data.

4. The route generation apparatus of claim 1,
wherein the circuit is further configured to output a display signal for displaying on a display, a three-dimensional model based on the three-dimensional data.

5. The route generation apparatus of claim 1,
wherein the circuit is further configured to:
receive second region information that specifies a second region comprising part of the depth image; and
generate route data for capturing the first region without entering the second region.

6. The route generation apparatus of claim 1,
wherein the circuit is further configured to generate the route data in which a distance to the first object is given based on a resolution used for capturing the first region and/or a size of a region with specific characteristics on the first object.

7. The route generation apparatus of claim 1,
wherein the circuit is further configured to:
extract a region with specific characteristics on the first object; and
generate route data for acquiring an image focusing on the extracted region.

8. The route generation apparatus of claim 1, further comprising
a transmitter configured to transmit the route data to a moving object comprising an image capture device.

9. The route generation apparatus of claim 1,
wherein the route data indicates a route for capturing the first region.

10. The route generation apparatus of claim 1,
wherein the depth image is acquired together with an image at one image capture by a single imaging optical system.

11. The route generation apparatus of claim 5, further comprising
a transmitter configured to transmit the route data to a moving object comprising an image capture device
and wherein the route data indicates a route for capturing the first region.

12. A route control system comprising:
a memory;
a circuit coupled with the memory; and
a moving object provided with an image capture device,
wherein the circuit is configured to:
acquire a depth image regarding a capturing object including a first object;
generate three-dimensional data by using the depth image;
receive first region information that specifies a first region including at least part of the first object based on the three-dimensional data; and
generate route data by using the first region information and the three-dimensional data, and
wherein the moving object is configured to move based on the route data.

13. A route generation method comprising:
acquiring a depth image regarding a capturing object including a first object;
generating three-dimensional data by using the depth image;
receiving first region information for specifying a first region including at least part of the first object based on the three-dimensional data; and
generating route data for capturing the first region by using the first region information and the three-dimensional data.

14. The generation method of claim 13, further comprising:
acquiring an image comprising the first object; and
generating the three-dimensional data by using the depth image and the image.

15. The route generation method of claim 13, further comprising
generating projection data obtained by projecting the three-dimensional data on a two-dimensional plane,
wherein the first region information is generated by using the projection data.

16. The route generation method of claim 13, further comprising
outputting a display signal for displaying on a display, a three-dimensional model based on the three-dimensional data.

17. The route generation method of claim 13, further comprising:
receiving second region information that specifies a second region comprising part of the depth image; and
generating route data for capturing the first region without entering the second region.

18. The route generation method of claim 13, further comprising
generating the route data in which a distance to the first object is given based on a resolution used for capturing the first region and/or a size of a region with specific characteristics on the first object.

19. The route generation method of claim 13, further comprising:
extracting a region with specific characteristics on the first object; and
generating route data for acquiring an image focusing on the extracted region.

20. The route generation method of claim 13, further comprising
transmitting the route data to a moving object comprising an image capture device.
